(19) United States
(12) Patent Application Publication
(10) Pub. No.: US 2004/0240785 A1
(43) Pub. Date: Dec. 2, 2004

(54) Optical coupling lens system and method for manufacturing the same

(76) Inventors: Sang-Dong Lee, Hwaseong-shi (KR); Sang-Ho Lee, Suwon-shi (KR)

Correspondence Address: CHA & REITER, LLC, 210 ROUTE 4 EAST STE 103, PARAMUS, NJ, 07652, US

(21) Appl. No.: 10/730,594

(22) Filed: Dec. 8, 2003

(30) Foreign Application Priority Data
May 28, 2003 (KR) 2003-34065

(51) Int. Cl. G02B 6/32

(52) U.S. Cl. 385/33

(57) ABSTRACT

Disclosed is an optical coupling lens system. The optical coupling lens system comprises a first lens having at least a first curved surface, and a second lens having at least a second curved surface, wherein the first and second lenses are bonded together with the first and second curved surfaces opposite to each other.

### CLAIM OF PRIORITY

This application claims priority to an application entitled “Optical Coupling Lens System and Method for Manufacturing the Same,” filed in the Korean Intellectual Property Office on May 28, 2003 and assigned Serial No. 2003-34065, the contents of which are hereby incorporated by reference.

### BACKGROUND OF THE INVENTION

1. Field of the Invention

The present invention relates to an optical device, and more particularly to an optical coupling lens system used for optical coupling between two different optical devices.

2. Description of the Related Art

In the field of optical communication, it is known to use an optical lens for optical coupling between a laser diode and an optical fiber. The optical lens is exemplified by an inexpensive spherical lens having a low optical coupling efficiency and an expensive aspherical lens having a high optical coupling efficiency.

FIG. 1 is a schematic view of an optical coupling procedure using a conventional spherical lens. FIG. 1 shows a laser diode 110 for outputting light having a preset wavelength, a spherical lens 120, having opposite ends of a spherical surface, for converging rays of light outputted from the laser diode 110, and an optical fiber 130 for propagating the converged light rays. The optical fiber 130 is comprised of a core 132, functioning as an optical transmission medium. It also has a clad 134 surrounding the core 132. The spherical lens 120 has a great spherical aberration. Therefore, in the case of light rays 115 incident to the spherical lens 120, a converged position is greatly changed according to a change of the incident position. It can be seen that light rays 115 passing through a central section as well as an edge section of the spherical lens 120 have different converged positions. Because the light rays 115 that fail to converge into one end of the optical fiber 130 are lost, the optical coupling efficiency is greatly decreased. Typically, the spherical lens 120 has a low optical coupling efficiency of about 10%. However, since spherical lens 120 has a low price, it has been widely used.

FIG. 2 is a schematic view of an optical coupling procedure using a conventional aspherical lens. FIG. 2 shows a laser diode 210 for outputting light having a preset wavelength through its one side, a spherical lens 220, having opposite ends of an aspherical surface, for converging light rays 215 outputted from the laser diode 210, and an optical fiber 230 for propagating the converged light rays 215. The optical fiber 230 is comprised of a core 232 functioning as an optical transmission medium. It also has a clad 234 surrounding the core 232. The aspherical lens 220 is designed to have a spherical aberration smaller than that of the spherical lens. It can be seen that light rays 215 passing through a central section as well as an edge section of the aspherical lens 220 have similar converged positions. This is due to a characteristic of the aspherical surface by which the spherical aberration is compensated. Typically, the aspherical lens 220 has a high optical coupling efficiency of about 40 to 80%. However, aspherical lenses have a high price.

As mentioned above, conventional optical coupling devices have difficulty in simultaneously satisfying the requirements of a high optical coupling efficiency and a low price.

### SUMMARY OF THE INVENTION

Accordingly, the present invention has been made to reduce or overcome the above-mentioned problems occurring in the prior art. One object of the present invention is to provide an optical coupling lens system and method for manufacturing the same, capable of simultaneously ensuring a high optical coupling efficiency and a low price.

According to one aspect of the present invention, an optical coupling lens system is provided, comprising: a first lens having at least a first curved surface; and a second lens having at least a second curved surface, wherein the first and second lenses are bonded together with the first and second curved surfaces opposite to each other.

According to another aspect of the present invention, a method for manufacturing an optical coupling lens system is provided, the method comprising the steps of: (a) forming a mask on a front surface of a substrate, wherein the mask has at least one empty space and the spaces are apart from each other; (b) forming a photosensitive layer in the space of the mask; (c) heating the photosensitive layer to form a curved surface; (d) etching the photosensitive layer to form the front surface of the substrate located under the photosensitive layer; and (f) bonding two substrates formed by the previous steps so that the curved surfaces of the substrates are opposite to each other.

### BRIEF DESCRIPTION OF THE DRAWINGS

The present invention will be more apparent from the following detailed description taken in conjunction with the accompanying drawings, in which:

FIG. 1 is a schematic view of an optical coupling procedure using a conventional spherical lens;

FIG. 2 is a schematic view of an optical coupling procedure using a conventional aspherical lens;

FIG. 3 is a schematic view of an optical coupling procedure using an optical coupling lens system according to a preferred embodiment of the present invention;

FIG. 4 is a perspective view of the optical coupling lens system shown in FIG. 3;

FIG. 5 is a partial perspective view of the optical coupling lens system shown in FIG. 4;

FIG. 6 is a graph showing the coupling efficiency of the optical coupling lens system shown in FIG. 3; and

FIGS. 7 to 17 show a method of manufacturing an optical coupling lens system according to a preferred embodiment of the present invention.

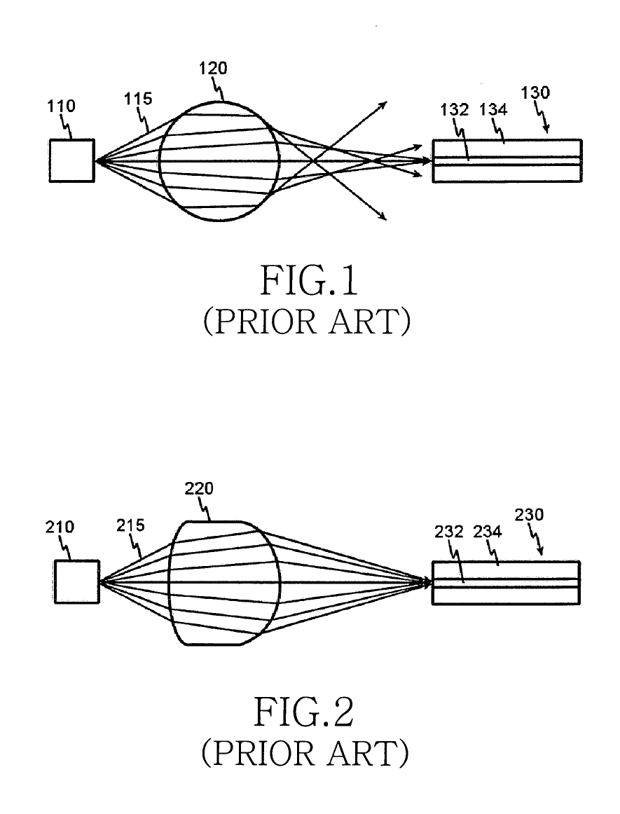

### DETAILED DESCRIPTION OF THE PREFERRED EMBODIMENT

Hereinafter, preferred embodiments of the present invention will be described in detail with reference to the accompanying drawings. For the purposes of clarity and simplicity, a detailed description of known functions and configurations incorporated herein will be omitted as it may make the subject matter of the present invention unclear.

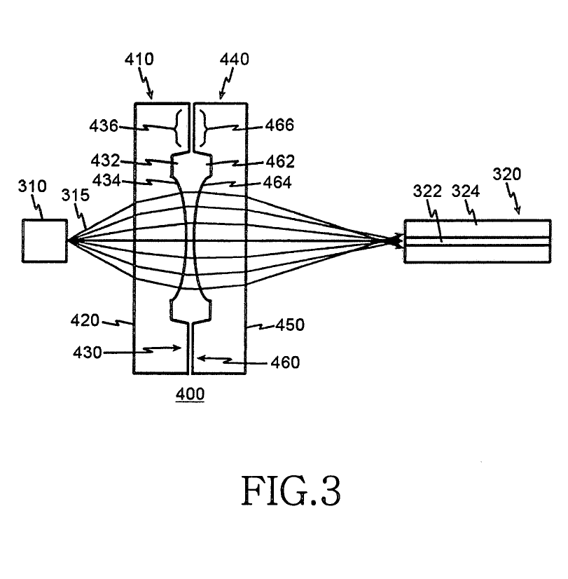

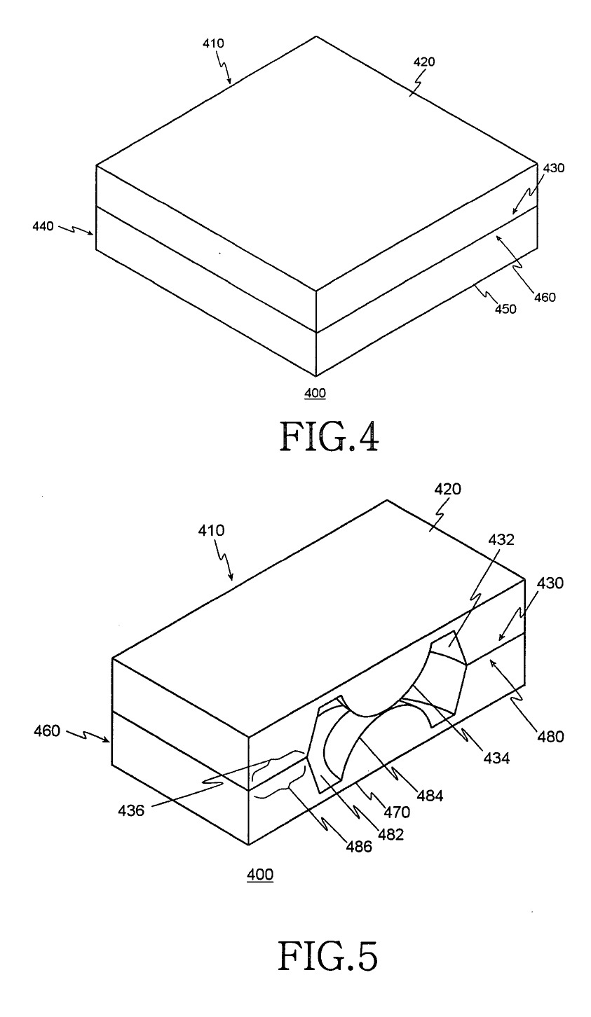

FIG. 3 is a schematic view of an optical coupling procedures using an optical coupling lens system according to a preferred embodiment of the present invention. FIG. 4 is a perspective view showing the optical coupling lens system shown in FIG. 3. FIG. 5 is a partial perspective view showing the optical coupling lens system shown in FIG. 4. It is noted that the optical coupling lens system shown in FIG. 3 is for explanation purposes and is not meant to limit the present invention in any way. FIG. 3 shows a laser diode 310 for outputting light having a preset wavelength through one side, an optical coupling lens system 400 for converging light rays 315 outputted from the laser diode 310, and an optical fiber 320 for propagating the converged light rays 315. The optical fiber 320 is comprised of a core 322 functioning as an optical transmission medium. It also includes a clad 324 surrounding the core 322.

The optical coupling lens system 400 includes first and second lenses 410 and 440, which are bonded each other. Each of the first and second lenses 410 and 440 is obtained by forming a substrate. The first lens 410 is provided with a flat rear surface 420 and a curved front surface 430. The second lens 440 is also provided with a flat rear surface 450 and a curved front surface 460. The front surfaces 430 and 460 include grooves 432 and 462 and flat bonding surfaces 436 and 466 surrounding the grooves 432 and 462, respectively. The grooves 432 and 462 are formed with lens surfaces 434 and 464, each of which is projected from a bottom surface of each groove. The flat bonding surfaces 436 and 466 of the first and second lenses 410 and 440 are bonded to each other. Light rays 315 outputted form the laser diode 310 are incident to the rear surface 420 of the first lens 410 and pass through an interior of the first lens 410. The first lens 410 is made of a semiconductor material and has a high refractive index. The light rays 315 are then emitted through the front surface 430 of the first lens 410. The emitted rays 315 pass through a layer of air and are incident to the front surface 460 of the second lens 440 and pass through an interior of the second lens 440. The second lens 440 is made of a semiconductor material and has a high refractive index. The light rays 315 are then emitted through the rear surface 450 of the second lens 440. Through this course, the light rays 315 emitted from the laser diode 310 are converged by the first and second lenses 410 and 440. The converged rays 315 are directed inside the optical fiber 320. The lens surfaces 434 and 464 of the first and second lenses 410 and 440 may be formed into an aspherical or spherical surface. Each of the first and second lenses 410 and 440 may be made of a semiconductor material, such as Si, InP, GaAs, and the like. Further, all the front and rear surfaces 430, 460; 420 and 450 of the first and second lenses 410 and 440 may be subjected to anti-reflection coating in order to reduce optical loss.

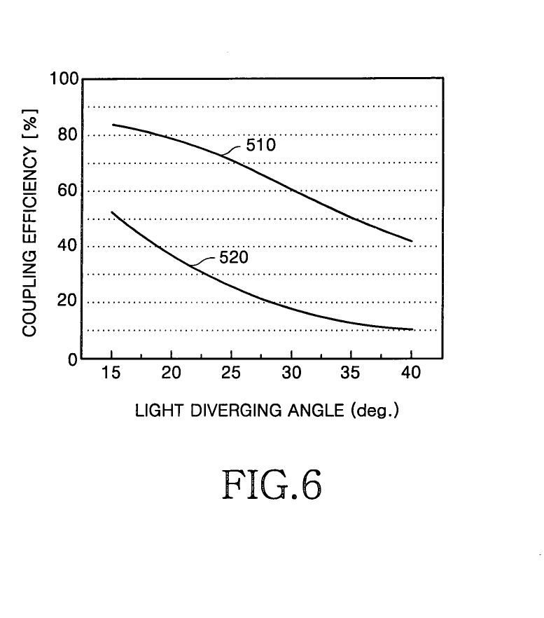

FIG. 6 is a graph showing the coupling efficiency of the optical coupling lens system shown in FIG. 3. Shown in FIG. 6, for comparison, are the coupling efficiency curve 510 of the optical coupling lens system 400, and that 520 of the convention spherical lens. The transverse axis shows a light diverging angle of the light emitting element, and the longitudinal axis shown the coupling efficiency. Further, the wavelength of light from the light emitting element is 1550 nm. The other details are listed in the following Table 1.

TABLE 1

| | | radius of curvature | | |
|---|---|---|---|---|
| | | of a spherical | | distance from a |
| | mat- | surface | thickness | light emitting |
| | erial | (mm) | (mm) | element |
| spherical lens | BK 7 | 0.75 | 1.5 | 1.0 |
| | glass | | | |
| optical | sili- | 3.0 (spherical | 1.0 × 2 | 0.5 |
| coupling lens | con | surface) | | |
| system 400 | | | | |

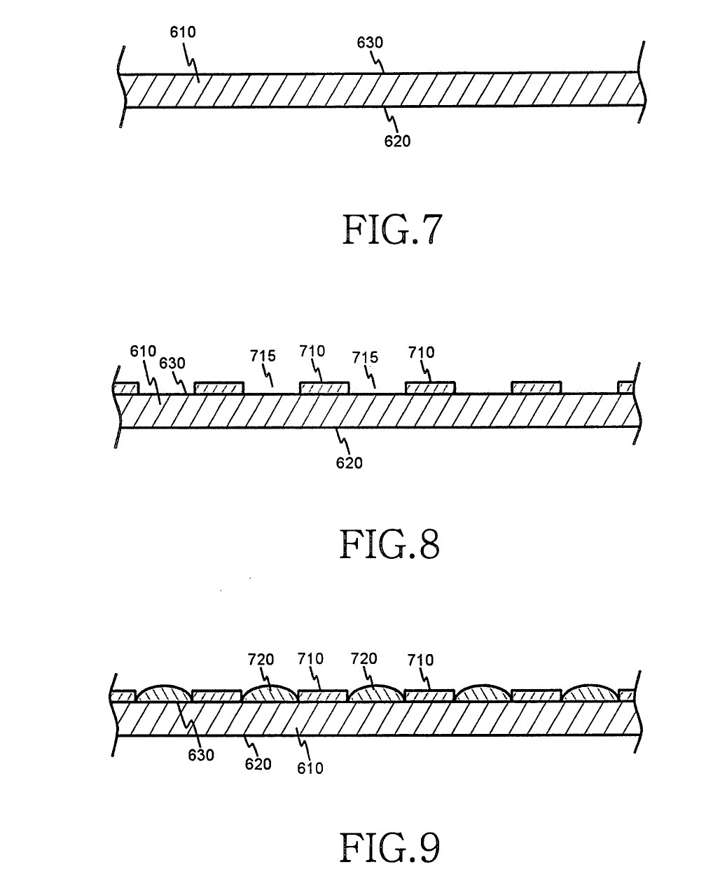

FIGS. 7 to 17 show a method of manufacturing an optical coupling lens system according to a preferred embodiment of the present invention. This manufacturing method includes the following processes.

FIG. 7 shows a first process wherein a semiconductor substrate 610 is prepared, in which a front surface 630 and a rear surface 620 are fine polished.

FIG. 8 shows a second process wherein a mask 710 of a metallic or dielectric material is deposited on the front surface 630 of the substrate 610 using a photolithography process. Here, the mask 710 is provided with a plurality of circular empty spaces 715, each of which have a shape of lens surface to be manufactured.

FIG. 9 shows a third process wherein each space 715 of the mask 710 is covered with a photosensitive layer 720. These photosensitive layers 720 are heated, so that their surfaces are formed into a spherical or aspherical surface.

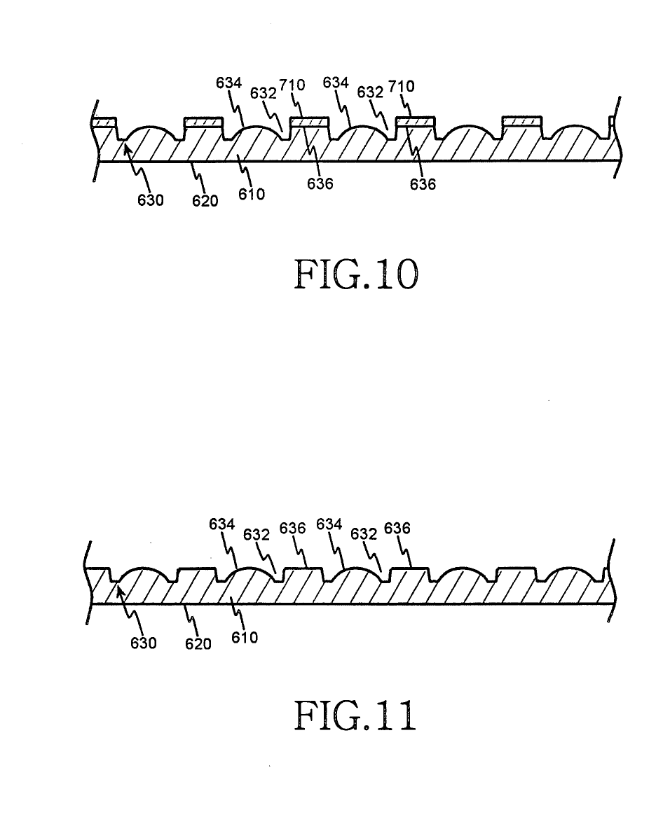

FIG. 10 shows a fourth process wherein the photosensitive layers 720 are etched using a dry etching process, so that portions of the substrate 610 located under the photosensitive layers 720 are formed in a curved shape. The portions of the substrate 610, which are etched along a profile of each photosensitive layer 720, are each formed with a groove 632. Each portion of the substrate 610, which is projected from the bottom surface of the groove 632, has a surface formed into a lens surface.

FIG. 11 shows a fifth process wherein the mask 710 remaining at the front surface of the substrate 610 is removed. The front surface 630 of the substrate 610, which is not etched by the etching process because it is covered by the mask 710, is formed into a flat bonding surface 636.

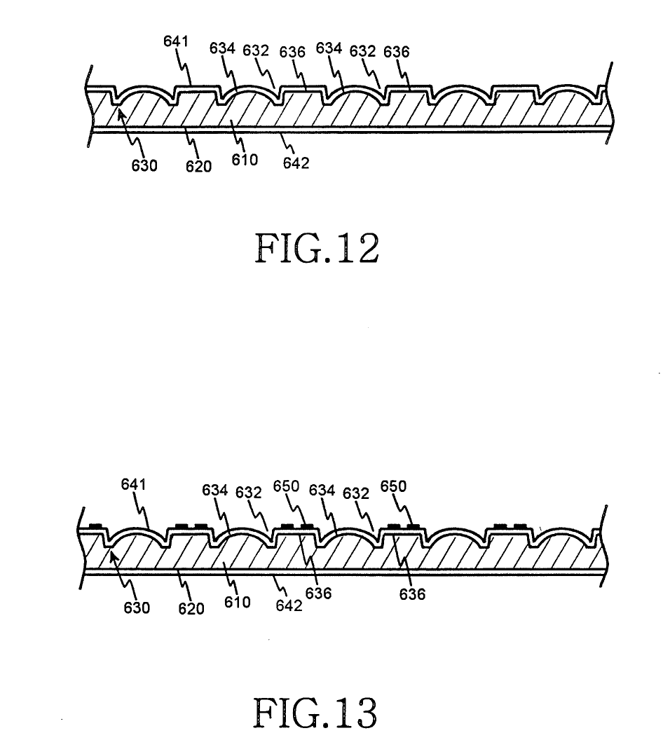

FIG. 12 shows a sixth process wherein the anti-reflection coating layers 641 and 642 of a dielectric material are formed on the front and rear surfaces of the substrate 610, respectively. The finished substrate 610 according to the sixth process is formed with identically shaped lenses.

FIG. 13 shows a seventh process wherein an adhesive material 650 is uniformly covered on the flat bonding surface 636 of the substrate 610, particularly at four corners around each lens. The adhesive material 650 may be exemplified by solder, epoxy and the like.

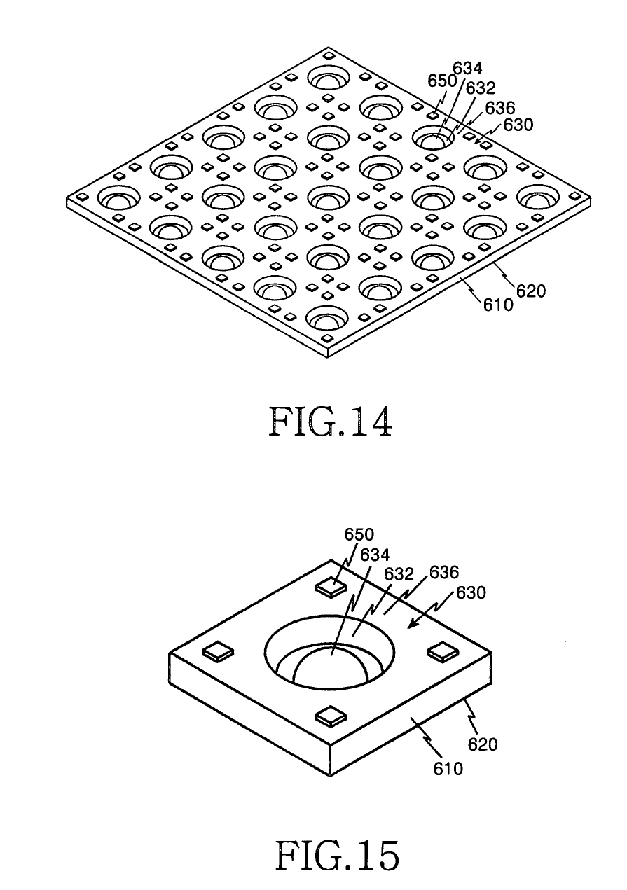

FIG. 14 shows the finished substrate 610 according to the seventh process. FIG. 15 is a partial perspective view showing any one lens of the substrate shown in FIG. 14. As shown in FIG. 15, each lens is obtained by forming the semiconductor substrate 610. They also have a flat rear surface 620 and a curved front surface 630. The curved front surface 630 includes a groove 632 and the flat bonding surface 636 surrounding the groove 632. A lens surface 634 is formed which is projected the bottom surface of the groove 632.

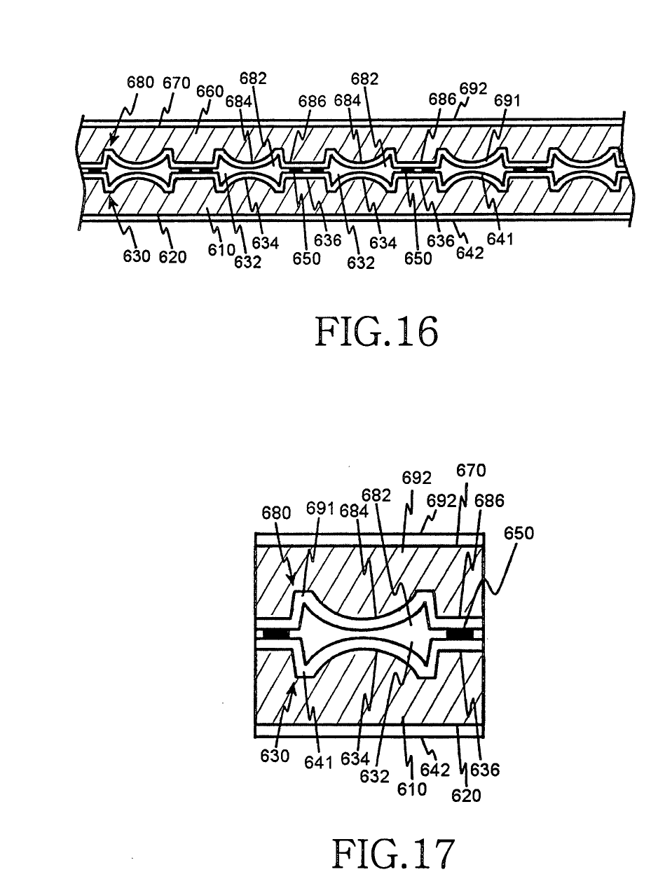

FIG. 16 shows an eighth process wherein either of the two identical substrates according to the seventh process are stacked in a manner that their front surfaces 630 and 680 are opposite to each other. Alternatively, two different substrates, one 610 according to the seventh process and the other 660 according to the sixth process, can be used. The substrates 610 and 660 are aligned to enable their lens surfaces 634 and 684 to face each other. After being stacked in this manner, the substrates 610 and 660 are firmly bonded by applying heat to the adhesive material 650.

FIG. 17 shows a ninth process wherein the bonded substrates 610 and 660 are cut into a unit of a lens system. Alternatively, the bonded substrates 610 and 660 may be cut into a unit of two lens systems or more.

Advantageously, according to the present invention, an optical coupling lens system and method for manufacturing the same enable mass production using a semiconductor manufacturing process, such as a photolithography process, so that the optical coupling lens system is manufactured at a low price.

Further, the optical coupling lens system according to the present invention can not only implement an aspherical lens surface with ease, but also obtain a high optical coupling efficiency as compared to a conventional spherical lens system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical coupling lens system, comprising:
a first lens having a first curved surface; and
a second lens having a second curved surface,
wherein the first and second lenses are bonded together with the first and second curved surfaces opposite to each other.

2. The optical coupling lens system according to claim 1, wherein the first and second lenses each have a flat rear surface and the first and second curved surface are on respective front surfaces.

3. The optical coupling lens system according to claim 2, wherein the first and second curved front surfaces each include at least one groove and a flat bonding surface surrounding the groove, wherein the groove is formed with a lens surface projected from a bottom surface of the groove.

4. An optical coupling lens system according to claim 3, wherein the flat bonding surfaces of the first and second lenses are bonded with each other.

5. An optical coupling lens system according to claim 1, wherein the first and second lenses have an anti-reflection coating on their respective rear and front surfaces.

6. An optical coupling lens system according to claim 1, wherein the first and second lenses are made of a semiconductor material.

7. The optical coupling lens system according to claim 6, wherein the semiconductor material is selected from the group consisting of Si, Inp, or GaAs.

8. A method for manufacturing an optical coupling lens system, comprising the steps of:
(a) forming a mask on a front surface of a substrate, wherein the mask has at least one empty space and the spaces are apart from each other;
(b) forming a photosensitive layer in a space of the mask;
(c) heating the photosensitive layer to form a curved surface;
(d) etching the photosensitive layer to form the front surface of the substrate located under the photosensitive layer; and
(f) bonding two substrates formed by the previous steps so that the curved surfaces of the substrates are opposite to each other.

9. The method according to claim 7, wherein the etching step includes forming the front surface in a wave form.

10. The method according to claim 7, further comprising a step of providing an anti-reflection coating to both opposite surfaces of each substrate, prior to step f.

11. The method according to claim 7, wherein prior to step f, a front surface of any one of the substrates is provided with an adhesive material.

12. The method according to claim 7, further comprising the step of cutting the bonded substrates into one or more units of a lens system.
